(19) United States
(12) Patent Application Publication
(10) Pub. No.: US 2004/0152039 A1
(43) Pub. Date: Aug. 5, 2004

(54) Dental adhesive strip

(76) Inventors: Mary L. Clegg, Indianapolis, IN (US); Dedi L. Turner, Greenwood, IN (US)

Correspondence Address: Richard C. Litman, LITMAN LAW OFFICES, LTD., P.O. Box 15035, Arlington, VA, 22215, US

(21) Appl. No.: 10/681,168

(22) Filed: Oct. 9, 2003

Related U.S. Application Data
(60) Provisional application No. 60/443,864, filed on Jan. 31, 2003.

(51) Int. Cl. A61C 5/04

(52) U.S. Cl. 433/39

(57) ABSTRACT

A flexible, transparent, dental adhesive strip having a dental adhesive uniformly coated onto one side of the strip for use during dental procedures. The strip is adhered to a tooth under repair to retain and shape a restorative material used to fill a void or cavity in the tooth. The strip may also be adhered to a tooth adjacent to a tooth under repair to provide protection against contact with materials used during the procedure on the tooth under repair.

### CROSS-REFERENCE TO RELATED APPLICATION

This application claims the benefit of U.S. Provisional Patent Application Serial No. 60/443,864, filed Jan. 31, 2003.

### BACKGROUND OF THE INVENTION

1. Field of the Invention

The present invention relates to a dental adhesive strip, and particularly to a clear, thin, dental strip with a dental adhesive on one side to hold the strip in place during dental procedures for the protection of adjacent teeth and for forming tooth anatomy.

2. Description of Related Art

In dental medicine, numerous procedures are performed on teeth to restore damaged or decayed tooth anatomy and to provide cosmetic improvements. Many of these procedures involve the application of composite resins and other materials to repair and reshape the tooth or fill in a cavity. Other procedures involve application of whitening and coloring agents to teeth for restorative purposes, such as tooth whitening or matching a repaired tooth to its neighbors. Still other procedures involve the use of various substances for etching or cementing. In these types of procedures, it is desirable to protect the adjacent teeth from contact with the materials used. Additionally, when using composite resins and other materials to repair and reshape a tooth it is often necessary to retain the material in a shape or contour matching the original shape and contour of the tooth while the material cures.

Dental matrices have been used to contain and manipulate restorative materials into desirable shapes and contours during restorative procedures. Matrices are also used as separators to prevent contact of a substance with adjacent teeth. Dental matrices are typically thin strips of metal, Mylar® (a trademark of E.I. duPont de Nemours & Co.), or similar materials. The strip is typically inserted between teeth and bent to conform to a tooth undergoing a restorative procedure to shape and contain a restorative material. In another method, the strip is inserted between teeth and bent around the tooth adjacent to the one that is to be worked on as a protective barrier. Once positioned, the matrix is held in place with a matrix retaining device, or by the fingers of the dentist or technician performing the procedure.

U.S. Pat. No. 3,305,928, issued on Feb. 28, 1967 to B. F. Tofflemire, discloses a dental matrix band along with a retainer for the band. The matrix band retainer is an instrument of a shape and configuration similar to a surgical clamp or forceps. The retainer is used to tighten the matrix band around a patient's tooth. U.S. Pat. No. 4,704,087, issued on Nov. 3, 1987, discloses a retainerless matrix band. The retainerless matrix band is preformed to function as a mold for retaining and forming a composite resin during a restoration procedure. Formed from a clear plastic material, the matrix allows for light-curing of the composite resin. However, because the matrix is preformed to a shape it lacks flexibility of use. It is primarily useful for restoration, and not as a protective shield for adjacent teeth. Additionally, the retainerless matrix band requires use of wedges or wedge shaped pins to hold the matrix in place and conform the matrix around the gingival margin.

The known metal matrix bands, similar Mylar strips, and the retainerless strips held in place by wedging all are prone to causing gingival bleeding caused by trauma inflicted by the matrix or its retaining devices or wedges. This is undesirable because blood may contaminate the restorative or cosmetic material used and compromise bond strength and aesthetics.

A dental matrix strip shown in U.S. Pat. No. 3,082,531, issued on Mar. 26, 1963 to R. J. Jacobson, is a strip that includes adhesive pads to secure the strip in place. The strip, about two inches long by about three-eights of an inch wide, has a wax pad on each end. The wax pad is about ½ inch square and 1/32 to 1/16 inch thick, and is made of a material such as paraffin wax or beeswax. These waxes display adhesive properties and will adhere to the strip, and to the teeth when applied. Additional additives enhance the adhesive properties. Because the wax pads limit the adhesion of the strip to its ends, this strip is of limited use. A strip in use cannot be practically altered in length or width without cutting away some or all of its adhesive pad. This strip thus cannot be modified to suit different procedures, various sizes or varied positions in the mouth.

U.S. Pat. No. 5,975,906, issued on Nov. 2, 1999 to E. J. Knutson, discusses several processes for forming dental restorations. The processes disclose the use a dead soft polymer strip of expanded polytetrafluoroethylene (PTFE) tape or sheeting as a dental matrix. The strip is a semi-opaque non-adhesive strip. The strip is held into place by a variety of methods, including using a known metal matrix and its retainer to hold the strip, using a roll formed by twisting a piece of the strip material into an elongated cylindrical shape which is wedged between teeth and the strip, using dental floss to wedge and hold the strip in place, and use of an oral adhesive applied to the teeth. Each of the processes discussed require several steps to place the strip for use in the procedure, and each requires one ore more additional elements such as a retainer, roll, dental floss, or an adhesive to be applied separately from the strip to fix the strip in place. The Knutson patent also discusses the use of another form of PTFE tape which is commonly known and available as plumbers tape. The adhesiveless, opaque, plumber's tape has generally proven inadequate because it is too fragile and difficult to use as a dental matrix.

None of the above inventions and patents, taken either singly or in combination, is seen to describe the instant invention as claimed.

### SUMMARY OF THE INVENTION

The dental adhesive strip is a dental matrix tape that has an adhesive on one side. The adhesive will hold the matrix tape in place for use. The clear strip may be dispensed from a roll to the desired length, and may be further cut or shaped to suit a variety of dental procedures. The strip may be inserted between teeth and secured to adjacent teeth during etching, bonding, and cementing procedures to protect the adjacent teeth from the materials used. The strip may also be formed into a matrix or stent to contain, shape, and contour materials used in restorative procedures. Because the strip is thin, it may be easily positioned between teeth. The clear material of the strip allows light-curing of various bonding and cementing compounds used with the strip.

Because the strip adheres to the tooth surfaces, the need for wedges and other retaining devices is eliminated. The elimination of these devices eliminates gingival bleeding that is typically associated with wedges and other matrix retainers, promoting better curing and bond strength of materials, better aesthetics, and improved oral health.

Accordingly, it is a principal object of the invention to provide a dental adhesive strip that has a dental adhesive on one side to secure the strip in place.

It is another object of the invention to provide a dental adhesive strip that will be self-secured in place without the need for a wedge or other retaining device.

It is a further object of the invention to provide a dental adhesive strip with a dental adhesive on one side, in which the strip can be modified in size or shape to any length or width without compromising its ability to be secured in place by the adhesive.

Still another object of the invention is to provide a dental adhesive strip that can be used in any area of the mouth to eliminate the need for many different types and sizes of matrix and retainer.

A further object of the invention is to provide a dental adhesive strip that can be used to protect adjacent teeth from contact with compounds used during cementing, etching, bonding, and other procedures.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a dental adhesive strip according to the present invention.

FIG. 2 is an environmental, perspective view of the dental adhesive strip with a reinforced edge positioned for insertion between adjacent teeth.

FIG. 3A is a cross-sectional view of the dental adhesive strip similar to FIG. 3B with an edge reinforced by folding the edge to make a double layer of the material.

FIG. 3B is a section view along lines 3B-3B of FIG. 2 showing an edge reinforced by folding the edge to make a double layer of the material and including a cord within the fold.

FIG. 4 is an environmental, top elevation view of the dental adhesive strip placed around a tooth under repair to contain and shape a restorative material.

FIG. 5 is an environmental, top elevation view of the dental adhesive strip placed around a tooth adjacent to a tooth under repair, to protect the adjacent tooth from contact with substances used during the repair procedure.

FIG. 6 is a perspective view of an embodiment of the dental adhesive strip in a supply roll form.

Similar reference characters denote corresponding features consistently throughout the attached drawings.

### DETAILED DESCRIPTION OF THE PREFERRED EMBODIMENT

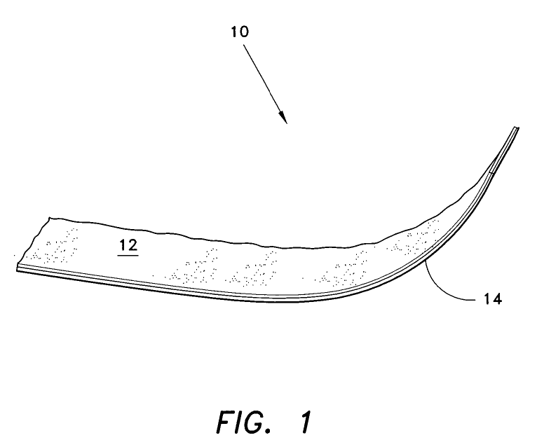

The present invention is a dental adhesive strip, designated generally as 10 in the drawings. As shown in FIG. 1, the dental adhesive strip 10 is formed of a transparent flexible strip 14 having a dental adhesive 12 uniformly coated onto one side. The transparent flexible strip 14 and the dental adhesive 12 are shown in the drawings with exaggerated thickness for clarity. The transparent flexible strip 14 is formed of a material that is flexible and moldable so that it can be conformed to the contours of the teeth. The transparent flexible strip 14 is thin to facilitate placement between the teeth. The transparent flexible strip is of sufficient strength to resist tearing during use, and especially while inserting the strip between contacts between the teeth.

The dental adhesive 12 is a transparent, orally compatible adhesive compound that will removably adhere the transparent flexible strip 14 to dental surfaces. The dental adhesive 12 is moisture resistant, for best performance in the oral environment, and will resist bonding with restorative materials so that the dental adhesive strip 10 strip may be easily removed. In one embodiment, the dental adhesive 12 is a light-curable adhesive that will allow the dental adhesive strip 10 to be placed and conformed to the teeth as necessary and then affixed to the teeth by light-curing the dental adhesive 12.

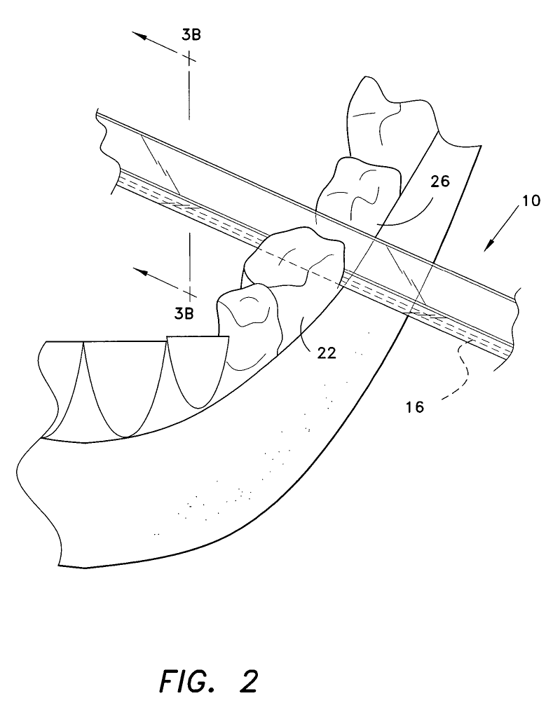

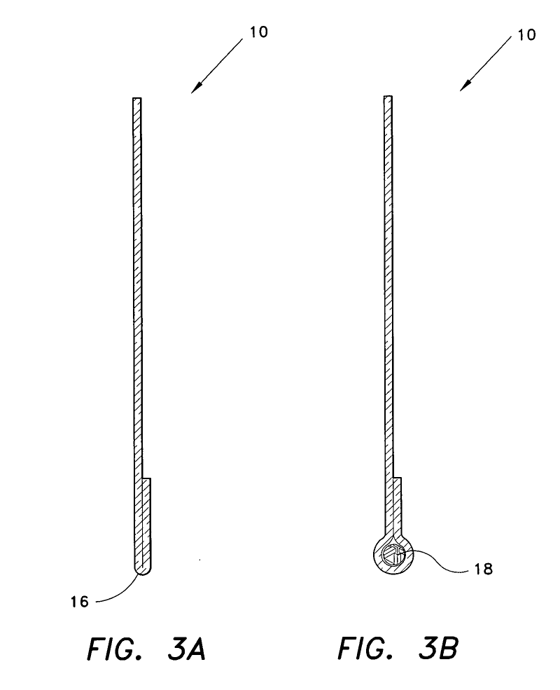

In another embodiment, shown in FIGS. 2-3, the dental adhesive strip has a reinforced edge 16. FIG. 2 shows the dental adhesive strip 10 with the reinforced edge 16 positioned for insertion between adjacent teeth. As shown in FIG. 3A, the reinforced edge 16 may be formed by folding an edge of the dental adhesive strip 10 to form a double layer of the strip material. In order to further reinforce the edge 16, a thin cord 18, such as dental floss or a thin wire or the like, may be disposed longitudinally within the reinforced edge 16 to provide additional strength, as shown in FIG. 3B. The reinforced edge 16 will allow the dental adhesive strip to be more easily placed through contacts between teeth.

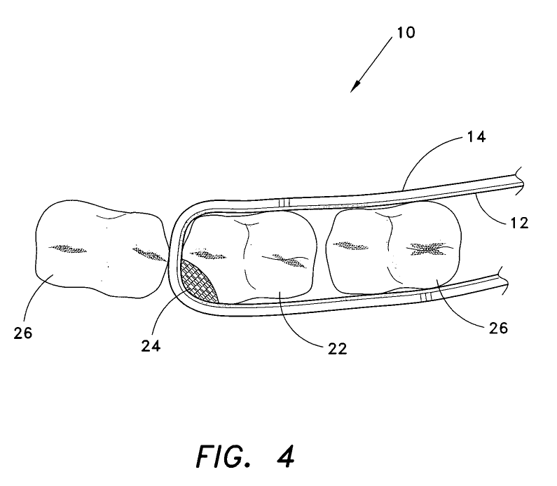

The dental adhesive strip 10 can be used during dental procedures for a variety of purposes. In one usage, shown in FIG. 4, the dental adhesive strip 10 is inserted between a tooth under repair 22 and an adjacent tooth 26 with the dental adhesive 12 facing the tooth under repair 22. The dental adhesive strip 10 serves to retain and shape a restorative material 24 that is used to fill a void or cavity in the tooth under repair 22. The dental adhesive strip 10 is held in place during the procedure by the dental adhesive 12. The dental adhesive strip 10 may be affixed to the tooth under repair 22 and adjacent teeth 26 as necessary. The transparent nature of the dental adhesive strip 10 facilitates curing of light-curable materials commonly used in such procedures.

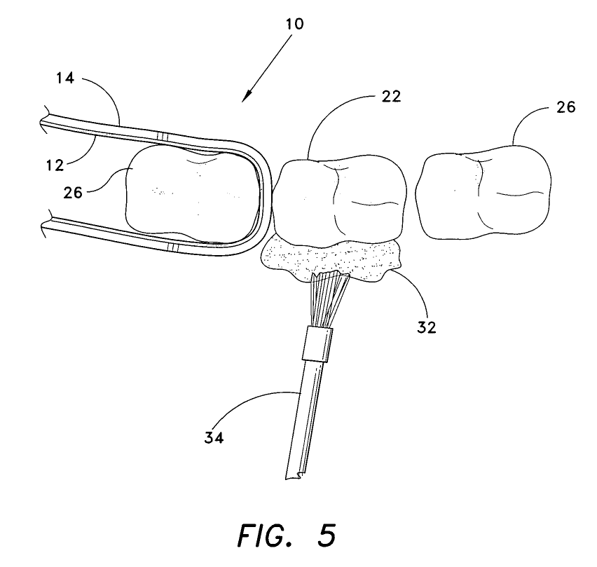

In another usage, shown in FIG. 5, the dental adhesive strip 10 is used to form a protective barrier for an adjacent tooth 26 to a tooth under repair 22. The dental adhesive strip 10 is inserted between the tooth under repair 22 and an adjacent tooth 26 with the dental adhesive 12 facing the adjacent tooth 26. The dental adhesive 12 affixes the dental adhesive strip 10 to and around the adjacent tooth 26, and other teeth as necessary. The dental adhesive strip 10 used in this manner protects the adjacent tooth 26 from contact with materials 32 that are applied to the tooth under repair 22 during the procedure.

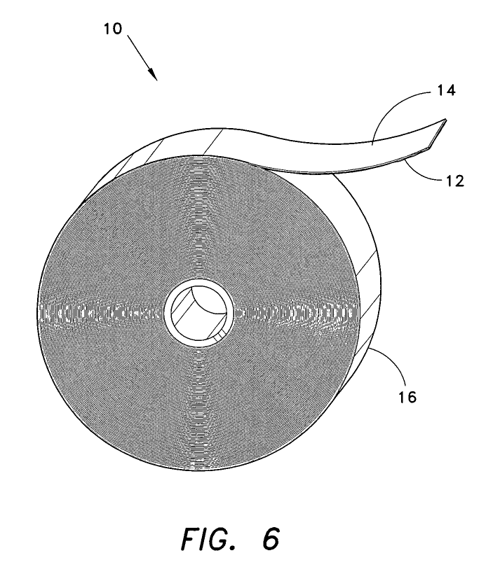

In either such procedure, the transparent nature of the dental adhesive strip 10 facilitates color-matching of materials used in treating the tooth under repair 22 to the color of the adjacent teeth 26. As shown in FIG. 6, the dental adhesive strip 10 may be made in the form of an elongated strip in a supply roll, from which a piece is cut to the desired length for use. The dental adhesive strip 10 may be further cut in width and shaped to suit differing needs.

It is to be understood that the present invention is not limited to the sole embodiments described above, but encompasses any and all embodiments within the scope of the following claims.

We claim:

1. A dental adhesive strip, comprising:
a flexible and moldable strip; and
a dental adhesive uniformly coated onto one side of said flexible strip.

2. The dental adhesive strip according to claim 1, wherein said flexible and moldable strip is transparent.

3. The dental adhesive strip according to claim 1, wherein said dental adhesive is a light-curable adhesive.

4. The dental adhesive strip according to claim 1, further comprising a reinforced edge.

5. The dental adhesive strip according to claim 4, wherein said reinforced edge is formed by folding an edge of said flexible strip to form a double layer of said flexible strip.

6. The dental adhesive strip according to claim 5, further comprising a thin cord longitudinally disposed within said double layer of said flexible strip.

7. A method for using a dental adhesive strip according to claim 1, comprising the steps of:
(a) preparing a tooth under repair;
(b) inserting the dental adhesive strip between the tooth under repair and an adjacent tooth with the adhesive side of the strip facing the tooth under repair;
(c) shaping the dental adhesive strip around the tooth under repair to form a retainer and form for a restorative material;
(d) adhering the dental adhesive strip to the tooth under repair and adjacent teeth;
(e) adding a restorative material to the tooth within the retainer and form created by the dental adhesive strip;
(f) allowing the restorative material to cure; and
(g) removing the dental adhesive strip.

8. A method for using a dental adhesive strip according to claim 1, comprising the steps of:
(a) preparing a tooth under repair;
(b) inserting a dental adhesive strip between the tooth under repair and an adjacent tooth with the adhesive side of the strip facing the adjacent tooth;
(c) shaping the dental adhesive strip around the adjacent tooth to form a protective barrier around the adjacent tooth;
(d) adhering the dental adhesive strip to the adjacent tooth;
(e) performing a dental procedure on the tooth under repair while the dental adhesive strip protects the adjacent teeth from contact with materials used during the procedure; and
(f) removing the dental adhesive strip.
